(19) United States
(12) Patent Application Publication
(10) Pub. No.: US 2009/0191953 A1
(43) Pub. Date: Jul. 30, 2009

(54) Method of organizing a collective on-line game

(76) Inventor: Roland Moreno, Paris (FR)

Correspondence Address: JACOBSON HOLMAN PLLC, 400 SEVENTH STREET N.W., SUITE 600, WASHINGTON, DC, 20004, US

(21) Appl. No.: 12/289,037

(22) Filed: Oct. 17, 2008

Related U.S. Application Data
(63) Continuation-in-part of application No. 12/010,519, filed on Jan. 25, 2008.

(51) Int. Cl. A63F 9/24; A63F 13/00

(52) U.S. Cl. 463/25

(57) ABSTRACT

The invention is implemented by a computer system comprising a game site administering a collective on-line game between a plurality of players, and a plurality of terminals available to the respective players. The method comprises at least one game session comprising the steps consisting in: a) selecting a first sub-population of adversary-players and a second sub-population, distinct from the first, of spectator-players, and associating these two sub-populations with a given game, the spectator-players being selected in a manner that ensures they are associated with adversary-players in an absolutely indeterminate manner; b) beginning the game between the adversary-players; c) communicating parameters describing the game to the spectator-players; d) authorizing the spectator-players to place respective bets; e) authorizing the spectator-player to place wagers on the outcome of the game, together with associated respective bets; and f) after the end of the game, allocating a score to each player in application of predefined criteria and as a function of the result of the game and of the bets placed by each player, this allocation being performed in distinct manners amongst the adversary-players and amongst the spectator-players.

### CONTEXT OF THE INVENTION

1. Field of the Invention

The invention relates to a method of organizing an on-line game.

It relates more particularly to organizing a collective on-line game, i.e. a game organized between a plurality of adversaries playing against one another.

More precisely, the invention relates to collective games that rely to a greater or lesser extent on the knowledge, the experience, or the shrewdness of players, as contrasted with games of pure chance such as lottos or casino games (which can usually be thought of as individual: games, insofar as even when a plurality of players are playing, confrontation between players is reduced to the simplest possible form).

2. Description of Related Art

Most on-line games presently on offer are individual games, i.e. each web user plays essentially “against the site” and not against other players, nor with the help of other players, even if a plurality of players can naturally be connected simultaneously to the site.

Collective on-line games are often transpositions of known games such as bridge, poker, etc. They present the drawback of being restricted to a closed circle of participants (for example poker is organized as “tables” of 4, 5, 6, . . . players). It is also necessary for each player to: know the rules thoroughly in order to be able to participate in such a game, and to establish a certain level of competence so as to make it possible to:bring together players of more or less uniform level. These requirements are often dissuasive for novice players, who turn away from sites of this type since they consider them as being reserved for the initiated.

In these games, emulation between adversaries is greatly increased by giving them the chance to place bets, which bets can be increased throughout the play of a game, as is for example entirely characteristic and illustrative of the game of poker: with each new bet that is placed, the hope of winnings is increased, said winnings generally being greater when the bet is greater.

Such bets are usually expressed in terms of points or chips that might be convertible into sums of money. Placing bets is naturally a major emulation factor of the game, but constitutes a risk taken by the player, and that might put a brake on the development of the game site, unless it requires bets to be small, but that has the counterpart of little being at stake, and thus of reducing motivation.

### SUMMARY OF THE INVENTION

The invention proposes a novel method of organizing a collective on-line game that can make the game accessible to a large number of players, i.e. not only to the circle of adversaries constituted by the active participants in the game, but also, and above all, other people, outside the circle of adversaries.

One of the objects of the invention is to make this participation possible even if the outside players are not completely knowledgeable about all of the rules of the game, and regardless of their own levels or degrees of experience in the game in question. For these other players, the motivation is above all to be entertained, together with the hope of winnings, but without necessarily seeking to test their own knowledge, experience, or skill at the game.

In another aspect, the invention provides a game which, without requiring players to place bets in the form of sums of money (or without a subscription, registration fee, purchase obligation, or analogous practice), they are nevertheless given the hope of obtaining concrete winnings. Thus, at the end of the game, those players who are not amongst the winners are merely “non-winners” but they are not losers: since they have not staked any sum of money, they are not made poorer in any way.

To achieve the above-specified objects, the invention provides a method of organizing a collective on-line game, implemented by means of a computer system comprising: a game site suitable for administering a collective on-line game between a plurality of players, the game being characterized by a predetermined body of rules open to being known to all of the players of said plurality, and each play of the game being characterized by an initial deal and by varying parameters that describe the play at any given instant; and a plurality of terminals available to respective players, each terminal being coupled to the game site to transmit to the site data input by the respective players, and to receive from the site data in return. This method comprises at least one game session comprising steps consisting in:

a) selecting a first sub-population of adversary-players and a second sub-population, distinct from the first, of spectator-players, and associating these two sub-populations with a given game, the spectator-players being selected in a manner that ensures they are associated with adversary-players in an absolutely indeterminate manner;

b) beginning the game between the adversary-players;

c) communicating parameters describing the game to the spectator-players;

d) authorizing the spectator-players to place respective bets;

e) authorizing the spectator-player to place wagers on the outcome of the game, together with associated respective bets; and

f) after the end of the game, allocating a score to each player in application of predefined criteria and as a function of the result of the game and of the bets placed by each player,

this allocation being performed in distinct manners amongst the adversary-players and amongst the spectator-players.

Step c) may comprise in particular the spectator-players placing at least one bet on a given adversary-player wining or losing at the end of the game.

While play is taking place, provision can be made for an additional step of communicating to at least one spectator-player, at his or her request, at least one additional item of information suitable for increasing knowledge about the game in question and for improving the odds for his or her wagers. Communicating this additional information will give rise to the application of requested compensation to the spectator-player that receives it.

Advantageously, provision is also made for steps consisting in:

g) setting up an endowment to be shared between the players; and

h) sharing said endowment out as a plurality of prizes for awarding to the players as a function of the respective scores they have obtained, and in manners that are different amongst adversary-players and amongst spectator-players.

Under such circumstances, in a preferred implementation, paid-for advertisements are displayed on the terminals of the players, and the endowment is a function of the level of revenues associated with said paid-for advertisements. This endowment may in particular be a predetermined percentage of the level of said revenues as evaluated over a period of time preceding the award of said endowment.

It is also possible to make provision for measuring the activity of the site by means of a traffic index representative of the number of players who have participated in the game during a given session. Paid-for advertisements are then paid for on the basis of a given tariff and of an amount of advertising space allocated to the advertisements, and the tariff for advertisements and/or advertising space allocated thereto is a function of the tariff index as measured during earlier sessions of the game.

The method of the invention can also make provision for a step of analyzing all of the bets placed by the various players, with a score being awarded as a function of the relevance of the bets placed by the players, and then a step of classifying players as a function of their scores, in different manners amongst adversary-players and amongst spectator-players.

### DETAILED DESCRIPTION OF THE PREFERRED IMPLEMENTATION

An on-line poker game is taken as an example of an application of the invention.

An essential characteristic of the invention is the existence, amongst all of the web users participating in the game, of players of two types, referred to as “adversary-players” and as “spectator-players”. When the term “players” is used on its own, it should be understood as covering without distinction web users participating in the game as adversary-players and/or users participating in the game as spectator-players.

In conventional manner, the game site organizes poker tables between players, “adversary-players”, who are recruited arbitrarily, but not randomly, possibly taking account of a personal choice depending in particular on level of expertise, and of parameters such as age, gender, nationality, etc., possibly also with lots being drawn randomly.

The game played at the table is played using a body of rules defined in advance, known and applied by the adversary-players. These rules are available on the site and they are accessible to everyone, so that rules can be known accurately by all of the players participating in the game.

Most particularly in the example of poker, the game can have a multitude of forms and variants: Texas Hold'em, Homa, Horse, Schulse, . . . with varying details such as which cards are face-down or face-up, the number of cards in the deck (32 or 54 cards), whether three of a kind beats a straight or vice versa, how the pot is configured, with or without chipping, rebuying conditions, etc. which variants can themselves depend on the number of cards in the deck.

The example described below is a game of poker of the “French poker” or “five-card poker” type, each hand has five cards. An example of such a “five-card poker” game is that played in the famous scene in George Roy Hill's film The Sting.

The adversary-players thus united around a table confront one another (the game is a human-against-human game, there is no playing against a machine), and they also place bets, in applications of rules that are well known in the context of this game.

In a manner characteristic of the invention, the poker tables as organized in this way constitute a kind of “show” that is open not only to mere visitors, but also to other players referred to as “spectator-players” who are given the opportunity to make wagers or place bets around the game being played by the adversary-players.

The spectator-players do not participate in the game being played by the adversary-players, so they have no way of influencing the way that game progresses.

In order to avoid any risk of fraud, it is essential for the site to ensure, when spectator-players are registered, that there is absolutely no way of determining which table will be allocated to the spectator-player. It is essential to avoid a player being able to register deliberately simultaneously at a given table both as an adversary-player and as a spectator-player.

To achieve this, a visitor to the site who registers for the “show” in order to become a spectator-player is allocated a table by random drawing of lots from amongst a very large number of tables that have already been set up, possibly with a certain amount of modulation as a function of parameters such as level of expertise, age, gender, nationality, etc., in order to better match levels of expertise between players.

The random draw serves to ensure that anyone seeking to become a spectator-player has no control over the choice of the table where he or she will be able to observe and place bets.

In order to avoid any risk of fraud, the adversary-players are given pseudonyms generated by the site (e.g.: city names) each time the game is played. This is to ensure that the spectator-players have no way of knowing who are the individuals participating in the game. Furthermore, at a given site, it is essential to take all precautions to ensure that the correspondence between a pseudonym and the identity of a player can never be accessible to the spectator-players, even with the complicity of agents of the site.

To guard against potential malicious attacks from the outside, precautions also need to be taken when players register, such as passwords, and tests of the Captcha (registered trademark) type for distinguishing human users from robots, etc.

Once the various players (adversaries and spectators) have been brought together in this way about a single table, a game is started in conventional manner, the game site dealing to each of the adversary-players. The game then takes place in entirely conventional manner: bets are placed, cards are drawn, showdowns occur, etc., and the game site does no more than deal the cards and manage the bets.

In a manner characteristic of the invention, the spectator-players watching the game have all of the information about the way the game is progressing, and the game site gives them the possibility of also waging, associated with greater or smaller bets, about the final success, or possibly failure, of such and such an adversary-player at the table being observed, with all of the spectator-players united about the table following how the game is proceeding. The spectator-players then wager on the success of such and such a player, or possibly on the failure of such and such a player, with a bet being associated with each wager.

The spectator-players—who are not personally engaged in play—have a certain amount of information available to them about the game being played by the adversary-players. This information or these parameters describing the game comprise, in particular, the initial deal, together with any subsequent deals, and a certain amount of time-varying parameters that serve to describe the state of play at a given instant. Thus, for a poker table having four players:
each of the adversary-players sees on the screen of his or her terminal connected to the game site: his or her own hand; the amount in the shoe, to within one unit; the amount in the pot, to within one point; the number of additional cards drawn by each of the other three adversaries; and the amount bet by each of the other three adversaries; and
the spectator-players observing this table see the same parameters and in the same manner as the adversary-players.

In a particular implementation, the spectator-players can request additional information about the game, which information is not known to the adversary-players.

This additional information might assist the spectator-player in obtaining better knowledge about the game and in increasing chances of a successful wager.

The additional information that a spectator-player can thus obtain may comprise, for example:
viewing the hand of one or more adversary-players;
the cards that have been discarded by one or more adversary-players after the first deal;
the cards received by one or more adversary-players during the second deal;
etc.

This information is delivered by the site in return for payment in terms of money or points (“I pay 100 dollars or, 100 points, to see the hand of a second adversary-player”), or in return for a coefficient that reduces any winnings (“I can see the hand of a second adversary-player, but my final winnings, if any, will be reduced by 30%”).

As the game proceeds, the spectator-players can add to or correct their wagers on such and such a player. Wagers thus vary as play proceeds, with a corresponding incremental bet.

At the end of each game, a score is awarded to each adversary-player and to each spectator-player, in application of predefined criteria and as a function of the result of the game and of the stakes engaged by each player.

The points given to the wining player may be transformed into prizes of very varied kinds, or into sums of money by crediting an account such as an account of the PayPal or Google Checkout (registered trademarks) type, which are some of the best known examples of payment sites that are very well adapted to “micropayments”, i.e. to payments of sums even when very modest, only a few dollars or even less than one dollar. The invention can also be used to encourage players to open an account with such on-line payment sites, as described in particular in copending application U.S. Ser. No. 11/898,472 dated Sep. 12, 2007 (A method of developing the activity of an on-line payment site by means of an attractor site interfaced therewith), in the name of Moreno, the disclosure of which is incorporated by reference.

In a particular implementation of the invention, the final score given to each player (adversary-player and/or spectator-player) is advantageously calculated from a “characterization” of the bet placed by the player. This technique consists in applying a battery of predetermined criteria enabling a greater or smaller number of points to be allocated depending on whether such and such a criterion is or is not true. For example:
1000 points if the player's bet gives a score greater than the highest score proposed so far;
400 points if the player gives a score greater than the general average, as calculated over all players;
500 points if the player's bet gives a score that is at least 10% greater than the score of the preceding proposal from the same player;
200 penalty points if the player's bet is more than 10% lower than the general average, taken over all players; etc.

This method of calculation using “characterization” (a technique consisting in applying a battery of weighted criteria to a given response), presents the advantage of quantifying the relative performance of the player, i.e. the performance of that player relative to the other players. This is of particular interest for the spectator-players, who can be very numerous.

With a large number of criteria, the “graininess” of the characterization becomes very fine, i.e. it is almost certain that discrimination will be achieved (very low risk of ties) between the various players, even when there is a very large number of players. It is thus possible to establish a hierarchy of players based on their respective contributions to the game.

The following steps consist in classifying the players (adversary-players and/or spectator-players), in order to give them prizes. The classification may be performed at regular intervals, once a day or once a week, or after several sessions of the game.

Web users who have participated in the game are classified (differently for adversary-players and spectator-players) as a function of the final scores they have obtained, and prizes of monetary value are awarded to them as a function of a predetermined share-out key.

The present game can be used in particular in the context of a method of the “virtuous circle” type for developing the activity of an Internet site in which an increase in traffic serves to increase advertising revenues and thus to increase the endowment that can be offered to players, and so on, with this technique being described in particular in the following applications U.S. Ser. No. 11/802,774 of May 24, 2007 and U.S. Ser. No. 11/907,814 of Oct. 17, 2007 claiming priority for the earlier application, both in the name of Moreno, the disclosures of which are incorporated by reference.

The increase in the public awareness and the traffic of the site make it possible in particular to attract the attention of advertisers who will then seek to place advertisements with the operator of the site for display on the screens presented to the players. In a variant, or in addition, it is also possible to persuade longstanding advertisers on the game to accept an increase in tariff for the space they book, in spite of its small dimensions when implementing a game in accordance with the present invention.

These screens, in particular the screens of spectator-players, comprise i) a zone reserved for the game, and ii) a commercial zone. The progress of the game is displayed in the game zone, while the commercial zone is used for displaying advertising, e.g. of a well-known trademark seeking to sponsor the game.

It is also possible to set up a periodic endowment, e.g. on a daily basis, as a function of the advertising revenues generated in this way, the game site making it known that it will pay to the players 50% of its advertising revenues, for example.

The predetermined key for sharing prizes out between the web users as a function of the final scores they obtain by participating in the game may be as given in Table 1 below, for example.

TABLE 1

| Rank | Winnings | Per week | |
|---|---|---|---|
| 1 | | 1 | 10,000 |
| 2 | 1,000 | | |
| 3 | 1,000 | | |
| 4 | 1,000 | | |
| 5 | 1,000 | | |
| 6 | 1,000 | | |
| 11 | 1,000 | 10 | 10,000 |
| 12 | 100 | | |
| | 100 | | |
| 13 | 100 | — | |
| 14 | 100 | — | |
| 111 | 100 | 100 | 10,000 |
| 112 | 10 | | |
| 113 | 10 | | |
| 1,111 | 10 | 1,000 | 10,000 |
| 1,112 | 1 | | |
| 11,111 | 1 | 10,000 | 10,000 |
| 11,112 | | | |

In this table, if the site pays for example $50,000 per week to the players, then that amount is subdivided into 11,111 prizes, i.e. 1 prize of $10,000, 10 prizes of $1,000, 100 prizes of $100, 1,000 prizes of $10, and 10,000 prizes of $1.

Still in this example, there will thus be 11,111 winners each week from amongst the web users who have participated in the game. Players from 11,112 are “non-winners”, but they are not losers since all they have staked is points and not sums of money, so they have not lost anything or become poorer in any way.

1. A method of organizing a collective on-line game, implemented by means of a computer system comprising:
a game site suitable for administering a collective on-line game between a plurality of players, the game being characterized by a predetermined body of rules open to being known to all of the players of said plurality, and each play of the game being characterized by an initial deal and by varying parameters that describe the play at any given instant; and
a plurality of terminals available to respective players, each terminal being coupled to the game site to transmit to the site data input by the respective players, and to receive from the site data in return; and
the method comprising at least one game session comprising steps consisting in:
a) selecting a first sub-population of adversary-players and a second sub-population, distinct from the first, of spectator-players, and associating these two sub-populations with a given game, the spectator-players being selected in a manner that ensures they are associated with adversary-players in an absolutely indeterminate manner;
b) beginning the game between the adversary-players;
c) communicating parameters describing the game to the spectator-players;
d) authorizing the spectator-players to place respective bets;
e) authorizing the spectator-player to place wagers on the outcome of the game, together with associated respective bets; and
f) after the end of the game, allocating a score to each player in application of predefined criteria and as a function of the result of the game and of the bets placed by each player,
this allocation being performed in distinct manners amongst the adversary-players and amongst the spectator-players.

2. The method of organizing a game of claim 1, in which step c) comprises the spectator-players placing at least one bet on a given adversary-player winning at the end of the game.

3. The method of organizing a game of claim 1, in which step c) comprises the spectator-players placing at least one bet on a given adversary-player losing at the end of the game.

4. The method of organizing a game of claim 1, further including, during the play of said game, an additional step of communicating to at least one spectator-player, at the request thereof, at least one additional item of information suitable for increasing that player's knowledge about the game and improving the chances of his or her bet.

5. The method of organizing a game of claim 4, further including, in the event of said additional information being communicated, the application of compensation requested from the spectator-player receiving the information.

6. The method of organizing a game of claim 1, further comprising steps consisting in:
g) setting up an endowment to be shared between the players; and
h) sharing said endowment out as a plurality of prizes for awarding to the players as a function of the respective scores they have obtained, and in manners that are different amongst adversary-players and amongst spectator-players.

7. The method of organizing a game according to claim 6, in which:
paid-for advertisements are displayed on the terminals of the players; and
said endowment is a function of the level of revenues associated with said paid-for advertisements.

8. The method of organizing a game of claim 7, in which said endowment is a predetermined percentage of said level of revenues as evaluated over a period of time preceding the award of said endowment.

9. The method of organizing a game of claim 7, in which:
the activity of the site is measured by a traffic index representative of the number of players who have participated in the game during a given session;
said paid-for advertisements are established on the basis of a given tariff and of advertising space allocated to said advertisements; and
at least one of the advertisement tariff and the advertising space allocated to said advertisements is a function of said tariff index measured during earlier sessions of the game.
